(19) United States
(12) Patent Application Publication
(10) Pub. No.: US 2025/0094542 A1
(43) Pub. Date: Mar. 20, 2025

(54) Media Management and Distribution Systems and Methods

(71) Applicant: Intertrust Technologies Corporation, Berkeley, CA (US)

(72) Inventors: Albhy Galuten, Santa Monica, CA (US); Yutaka NAGAO, Minami-Alps (JP); Talal Shamoon, Berkeley, CA (US); Chitai Kenny Huang, New Taipei City (TW)

(73) Assignee: Intertrust Technologies Corporation, Berkeley, CA (US)

(21) Appl. No.: 18/885,078

(22) Filed: Sep. 13, 2024

Related U.S. Application Data
(60) Provisional application No. 63/582,749, filed on Sep. 14, 2023.

(51) Int. Cl. G06F 21/10

(52) U.S. Cl. CPC G06F 21/107

(57) ABSTRACT

Embodiments of the disclosed systems and methods provide for the management of the distribution and licensing of content using trusted ledgers and digital rights management techniques. In various embodiments, content creators and/or producers may reach agreements with service providers embodied as digital contracts with associated information recorded on trusted ledgers. Content parameter information included in these digital contracts may be leveraged by digital rights management services to ensure that conditions associated with the use and/or playback of content set by a content creator and/or producers are respected as a condition of license issuance. In this manner, digital rights management services may utilize trusted ledgers to ensure that content creator and/or producer rights are respected.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### REFERENCE TO RELATED APPLICATIONS

This application claims the benefit of priority under 35 U.S.C. § 119 (e) to U.S. Provisional Application No. 63/582,749, filed Sep. 14, 2023, and entitled “Accountable Media Production and Distribution Systems and Methods,” which is hereby incorporated by reference in its entirety.

### SUMMARY OF THE INVENTION

The present disclosure relates generally to systems and methods for managing media production, distribution, and rights management. More specifically, but not exclusively, the present disclosure relates to media production and distribution systems and methods that enhance the chain of distribution and consumption of media content, including content and copy production, distribution, consumption control and/or rights management, accountability, and/or monitoring.

Conventional digital rights management (“DRM”) systems are relatively robust within their limited scope of application. They may be somewhat limited, however, in their ability to efficiently manage controls, obligations, and/or permissions originating from a content creator, through multiple various distribution systems, to a consumer of the content. For example, in the context of movie distribution, film studios often have distribution agreements, which may be referred to as questionnaires, that are completed by service providers and outline what they are generally permitted to do with regard to protection and scope of content distribution, but there is often little granularity and accountability. In the current media distribution and consumption environment there is potential for mishandling of content mezzanine files and/or content encryption keys which may enable content leakage and lead to piracy.

In some conventional implementations, DRM may not be enforced directly by a service and content licensees may not always deploy the content protection solution properly or at all, even when the content license requires it. Content licensees may control data on audience consumption on their platforms, and they may be motivated to keep certain insights from content owners. This lack of transparency around the consumption often may result in lost studio revenue. Conventional DRM implementations further show potential vulnerabilities, with many of the commonly used clients being hacked and/or token hacks being used to gain illegal access to content.

Embodiments of the disclosed systems and methods may provide a variety of improvements over conventional DRM implementations and ameliorate some of the challenges detailed herein. For example and without limitation, content protection and management systems and methods consistent with various aspects of the disclosed embodiments may provide for one or more of:
A dynamically changeable and/or robust mechanism for describing very detailed descriptions of distribution rights and controls for groups of content and individual content elements.
Agreement by associated parties on the terms of rights and/or content controls.
Agreements being stored in a robust and immutable fashion.
Terms of the agreement(s) being enforced by DRM systems that are interoperable across different consumers, devices, systems, storage facilities, and/or immutable ledgers.
Content usage being tracked and reported in detail with very granular control over privacy.
Compliance obligations per title, per date, per territory, per distributor, and/or per channel, which may include title key duration before refresh.
For piracy mitigation, content licensees that may handle pre-encrypted content, potentially reducing the mismanagement of the files.
For DRM compliance, content licensees may not have an opportunity to curtail application of DRM because content may be encrypted, with the keys remaining with a viewer license management entity.
To increase data transparency, a relationship between a viewer license management entity and end users may allow for the collection of meaningful audience data on behalf of a content owner.

Embodiments of the disclosed systems and methods may be used in connection with the protection and/or management of a variety of types of content, media, and/or assets. For example, it will be appreciated that the disclosed systems and methods and aspects thereof may be employed in connection with a variety of types of assets, media, content, and/or data including, for example and without limitation, audio content, video content, multimedia content, software, data (which may comprise proprietary data and/or databases), and/or the like. In this manner, the terms “content,” “media,” “assets,” and/or derivatives as used herein thereof should be considered to encompass a relatively broad variety of possible types of media, content, and/or data.

Various content distribution and management systems and methods described herein may, in certain implementations, enable content creators and other stakeholders to exert more direct control and management over their content and associated rights within a distribution ecosystem. By reducing dependence on specific third-party entities within the content distribution framework, the disclosed embodiments may provide creators with enhanced control, transparency, and auditability concerning the distribution of their content to end consumers.

In one non-limiting example illustrating aspects of the disclosed embodiments, a content creator, possibly lacking the resources of a major production company, may use these systems to distribute content to various consumers through multiple distribution models, such as purchase, rental, or ad-supported models. Creators may define and enforce usage rules for their content using trusted ledger technologies, like blockchains, in combination with DRM services, which record and implement the conditions and parameters associated with content distribution and consumption. These content parameters, encapsulated in digital contracts recorded on a trusted ledger, can be dynamically executed and enforced across the ecosystem, allowing for scalable and reliable content management in both small and large-scale distribution paradigms.

A DRM service may query the trusted ledger to assess whether to generate and/or distribute a license to a requesting client device. The DRM service may examine the content parameters to determine if the conditions for license issuance, as indicated or expressed within these parameters, have been satisfied. If the conditions expressed or indicated in the content parameters are met, the DRM service may then proceed to issue a license to the requesting client device in accordance with the content parameters. In this manner, DRM services may be used to enforce agreement parameters recorded in a trusted ledger in connection with the issuance of licenses for content use and/or playback.

### BRIEF DESCRIPTION OF DRAWINGS

The inventive body of work will be readily understood by referring to the following detailed description in conjunction with the accompanying drawings, in which:

FIG. 1 illustrates a non-limiting example of a content provider agreement process consistent with certain embodiments disclosed herein.

FIG. 2 illustrates a non-limiting example of a content process flow consistent with certain embodiments disclosed herein.

FIG. 3 illustrates a non-limiting example of content management using a trusted ledger consistent with certain embodiments disclosed herein.

FIG. 4 illustrates a non-limiting example of a playback architecture consistent with certain embodiments disclosed herein.

FIG. 5 illustrates a non-limiting example of compliance validation consistent with certain embodiments disclosed herein.

FIG. 6 illustrates a non-limiting example of the management of re-encrypted content consistent with certain embodiments disclosed herein.

FIG. 7 illustrates a non-limiting example of various playback limiting parameters consistent with certain embodiments disclosed herein.

FIG. 8 illustrates a flow chart of a non-limiting example of a method for managing content using digital rights management license generation and issuance leveraging trusted ledgers consistent with certain embodiments of the present disclosure.

FIG. 9 illustrates an example of a system that may be used to implement certain embodiments of the systems and methods of the present disclosure.

### DETAILED DESCRIPTION OF THE INVENTION

A description of systems and methods consistent with embodiments of the present disclosure is provided herein. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to certain drawings. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure, but is merely representative of possible embodiments of the disclosure. In addition, the steps of any method disclosed herein do not necessarily need to be executed in any specific order, or even sequentially, nor need the steps be executed only once, unless otherwise specified. Moreover, it will be understood that, as used herein, a process and/or method step that is described as being “based on” some information is not necessarily exclusively based on that information, but indeed may be based at least in part on the information and/or a portion thereof and/or other information, even if not explicitly indicated as so. Additionally, it will be understood that the terms “entity,” “system,” and/or “service” may, in certain but not necessarily all, instances herein be used interchangeably.

It will be also appreciated that all examples described herein are intended to be illustrative of applications of various embodiments of the disclosed systems and methods to facilitate an understanding of the embodiments, and are not intended to be limiting examples, even if not specifically identified as such. For example, although various implementations are described the context of content distributed by a studio (e.g., a movie studio), it will be appreciated that the disclosed embodiments may be and/or otherwise used in a variety of other contexts including, for example and without limitation, in connection with recording and/or music studios, television production, book publishing, and/or any other suitable type of content production, distribution, and/or management context.

Various content distribution and associated management systems and methods described herein may, in some implementations, allow content creators and/or other parties to have more direct control and/or management of their content and/or rights in a distribution ecosystem. Reduced reliance on certain third parties in a content distribution ecosystem may be realized using certain disclosed embodiments, providing creators with improved control, transparency, and/or auditability of the distribution of their content to end consumers.

In at least one non-limiting example illustrating various aspects of the disclosed embodiments, a content creator may be an individual without resources of a major content production company. Using embodiments detailed herein, creators may make their content available to a variety of consumers via a variety of distribution models (e.g., purchase, rental, as-supported, etc.). Moreover, creators may have the ability to define their desired usage rules for consumption of their content. In various embodiments, trusted ledger (e.g., blockchain) and/or DRM technologies may be used to record and enforce certain rules, conditions, and/or parameters associated with the distribution of, consumption of, and/or other interactions with content, which in certain instances herein may be generally described as “content parameters” and/or derivatives thereof. For example, creators may post a link and/or other reference to their content (e.g., via e-mail, a social media network, etc.) that consumers may use to access applicable content parameters (e.g., a blockchain), and the associated parameters may be enforced by an applicable DRM service.

Content parameters may be embodied in digital contracts recorded on a trusted ledger such a blockchain. These parameters may be executed and enforced in connection with other ecosystem participants, allowing for dynamic and trusted management of associated content. Various embodiments disclosed herein may be relatively scalable, allowing for trusted content management in both smaller and larger distribution paradigms.

In various embodiments, DRM services may use content parameters recorded in one or more trusted ledgers in connection with license generation and/or distribution. For example and without limitation, a DRM service may check a blockchain ledger for applicable digital contracts included in a ledger articulating one or more content parameters for a particular piece of content. If various applicable content parameters included in the digital contract for the piece of content are satisfied, the DRM service may generate and distribute applicable DRM licenses to the requesting client.

Ledger entries reflecting content parameters may be structured in a variety of ways. For example and without limitation, a content creator may record in a trusted ledger an entry associating a content identifier, one or more indications of content parameters (e.g., rules, conditions, etc.), and/or relevant cryptographic signatures (e.g., creator signatures, signatures of other entities provide trust, etc.). Content parameters may, in some implementations, be recorded directly in the trusted ledger. In further embodiments, content parameters may be referenced in the ledger via a link location (e.g., a URL). In yet further embodiments, one or more hashes may be used to express content parameters and included in corresponding ledger entries.

A DRM service may query the trusted ledger when determining whether to generate and/or distribute a license to a requesting client. The DRM service may analyze the content parameters to determine whether one or more conditions for license issuance indicated and/or expressed in the parameters have been satisfied. If the one or more conditions expressed and/or otherwise indicated in the content parameters have been satisfied, the DRM may proceed to issue a license to a requesting client device consistent with the content parameters.

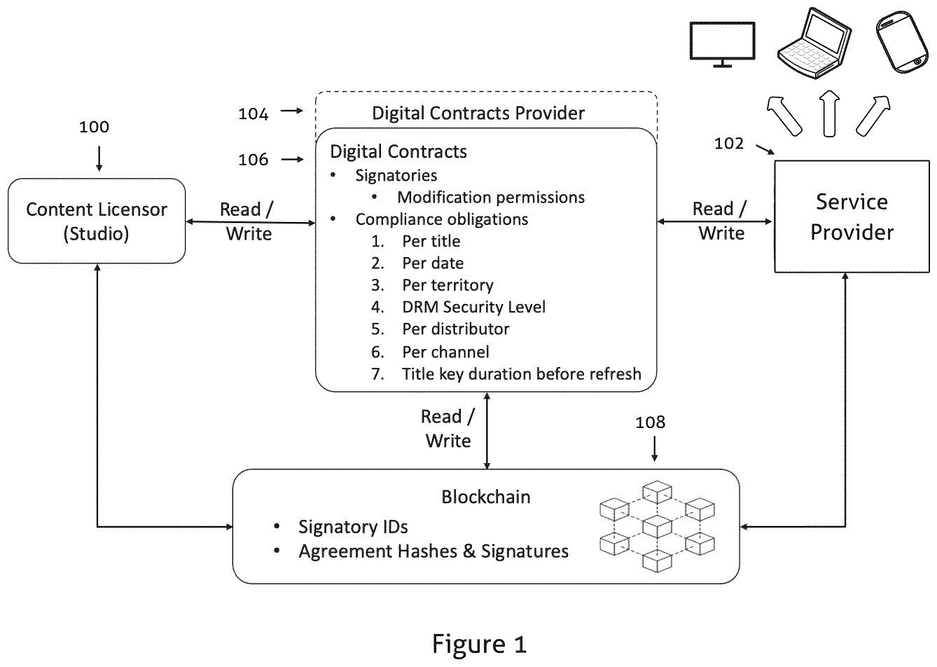

FIG. 1 illustrates a non-limiting example of a content provider and/or licensor agreement process consistent with certain embodiments disclosed herein. For purposes of illustration and explanation, the content provider and/or licensor 100 (generally referred to in the figures as a content licensor) are described in connection with a film studio in various embodiments and examples herein, although it will be appreciated that the various embodiments may be used in a variety of other contexts and with different kinds of content creators, providers, and/or rights holders. Moreover, although various non-limiting examples herein are described in connection with audio and/or visual content and/or media use cases for purposes of illustration and/or explanation, it will be appreciated that various embodiments may be used in connection with a variety of other contexts, use cases, and/or applications in connection with a variety of types of assets, media, content, and/or data.

Consistent with embodiments disclosed herein, content providers and/or licensors 100 may establish agreements with one or more service providers 102 for distribution and/or delivery of their content to consumers. The service provider(s) 102 may comprise a variety of content distribution services including, for example and without limitation, commercial cinema services, streaming services, television services, digital download services, and/or the like. It will be appreciated that a variety of service provider(s) 102 may interact with various aspect of the disclosed systems and/or services, and that example of service provider(s) detailed herein should not be viewed as limiting.

In some embodiments, agreements established between content providers and/or licensors 100 and one or more service providers 102 may be in the form of studio questionnaires. Studio questionnaires may comprise agreements that a content provider and/or licensor 100 requires their service providers 102 to complete as a condition of distributing their content. In some implementations, studio questionnaires may be completed by a content provider and/or licensor 100, service provider(s) 102, and/or associated third parties via any suitable method (e.g., online forms and/or interfaces). For example and without limitation, in various embodiments, the agreements may be created initially by being written into a web form. Consistent with embodiments disclosed herein, such agreements may be embodied and managed as digital contracts 106.

In some embodiments, blockchain services and/or environments may be configured to manage and potentially enforce certain digitals contracts as “smart contracts.” Consistent with embodiments disclosed herein, the various content parameters associated with a digital contract may be managed and/or otherwise enforced by DRM services in connection with the generation and/or issuance of DRM licenses to requesting clients required for playback and/or use of associated content. This may provide an enforcement mechanism separate from and/or in addition to any enforcement mechanism implemented by a blockchain service as part of a smart contract execution paradigm.

Digital contracts 106 consistent with the disclosed embodiments may be stored by a digital contracts provider 104 in a secure manner. For example and without limitation, digital contract 106 may be stored by the provider 104 in an encrypted form, although other methods of protecting and/or otherwise securing the digital contracts 106 managed by the provider 104 may also be used. A variety of information may be included in the digital contracts 106. In some embodiments, the digital contracts 106 may detail the distributor and/or other service provider rules, conditions, parameters, and/or obligations with regard to each piece of licensed content, which may be expressed collectively as a part of a group of licensed content and/or as an individual content item. For example and without limitation, in various embodiments, the digital contracts 106 may comprise one or more of a date of signing (e.g., physical and/or electronic execution), names and/or associated credentials of the signatories, the location of the digital contract 106 and an associated signature (for example and without limitation, an electronically signed version of the contract and/or other cryptographic signature associated with the signatory/signatories), and/or various conditions, obligations, and/or other information (which may in certain instances herein be referred to individually or collectively as content parameters).

Consistent with embodiments disclosed herein, digital contracts 106 and/or information associated with the same may be stored in a trusted ledger such as a blockchain 108. In various disclosed embodiments, immutable and/or otherwise secure ledgers, blockchains, and/or the like (which in certain instances herein may be generally referred to herein as “trusted ledgers” and/or variations of the same), may be used to record and/or otherwise manage various assertions and/or other information disclosed herein. In some embodiments, such blockchains and/or ledgers may be distributed, and may be referred to herein as trusted immutable distributed assertion ledgers (“TIDALs”) and/or variations of the same. In some embodiments, including many of the non-limiting illustrative examples included herein, trusted ledgers may comprise blockchain ledgers.

Blockchains and/or ledgers may, in various embodiments, be public, private, and/or a combination thereof. In certain embodiments, a trusted ledger may comprise a public indelible distributed database (“PIDD”). Trusted ledgers consistent with various aspects of the disclosed embodiments may be associated with a variety of properties including, for example, ledger processes that may be resistant to byzantine failures, entries that may be immutable and/or relatively immutable, entries that may be time-synced (at least in part), entries that may be scalable, and/or entries that may be available for relatively fast lookup.

Digital contracts 106 consistent with certain disclosed embodiments may be structured in a manner such that they can be examined by a rules-engine designed to interpret the associated rules, conditions, parameters, and/or obligations—that is, collectively the content parameters—included therein, and generate associated DRM licenses, potentially with client-side enforced rules, conditions, parameters, and/or obligations. When the details of the obligations are parsed within the context of the viewer's desire to consume the content, a client DRM engine may permit the content to be rendered and/or not and/or may control the relevant parameters of the rendering (e.g., playback resolution, etc.).

Consistent with embodiments disclosed herein, digital contracts 106 can express the management of rights in relatively detailed granularity. For example and without limitation: (1) rules can be different on a title-by-title basis, (2) rules can be different based on the date and/or time of distributing a license (3) rules can be different based on the date and/or time of allowable viewing, (4) rules can be different on a territory-by-territory basis, (5) rules can be different based on the DRM security level, (6) rules can be different based on which service provider is distributing the content, (7) rules can be geographic and/or location based (e.g., based on the location of the service provider 102 and/or client devices receiving, streaming, and/or otherwise access content from the service provider 102), and/or (8) rules can be different which channel or subscription tier they are distributing it on. Other rule paradigms supporting different content distribution and/or access models may be expressed in digital contracts 106 including, for example and without limitation, rules that grant on service provider exclusive rights to distribute a title during a certain time period in a certain location, while other service providers in the location may be granted rights to distribute a title at times outside the period. Because of the sophistication of such a rules engine, other non-limiting examples of consumption rules could be as varied as: rules relating to discounts based on recommendations from friends, with or without some share of the revenue going to the recommender, rules relating to rights to consume synchronously with other viewers or listeners, rules relating to rights to remove foreground objects and/or reuse backgrounds as derivative works either for free or for remuneration, rules relating to rights to modify the original work for reuse in other venues or in other configurations or in other new works, and/or the like. DRM services may interpret such rules when generating DRM licenses to ensure they are enforced in connection with the playback and/or use of associated content. In some embodiments, rules may comprise a combination of attributes and/or may be hierarchical in nature, with rule parsing and/or evaluation services using algorithm and/or hierarchical rule evaluation processes.

In various implementations, these variables can be taken together so that each element may determine under what conditions rendering is permitted and/or determine other allowed and/or required parameters associated with playback of the content. In some embodiments, requirements for parameters associated with content encryption keys and/or session keys may be specified, including, but not limited to scope of key usage, duration of key validity, frequency of key rotation/refresh, and/or the like. For example and without limitation, one content key can be used for a title and that can be used across all formats and territories for the duration of the time that the service provider has the rights to distribute the title.

To mitigate piracy risk, in some embodiments, the content provider and/or licensor 100 could use different keys for different resolutions or different keys for different territories or different keys for different service providers. In further embodiments, the digital contract 106 could require that some titles change content keys regularly, for example every week or every day or every hour, and/or use key rotation mechanisms that are continually rotating keys, thereby disincentivizing capture of the keys by pirates.

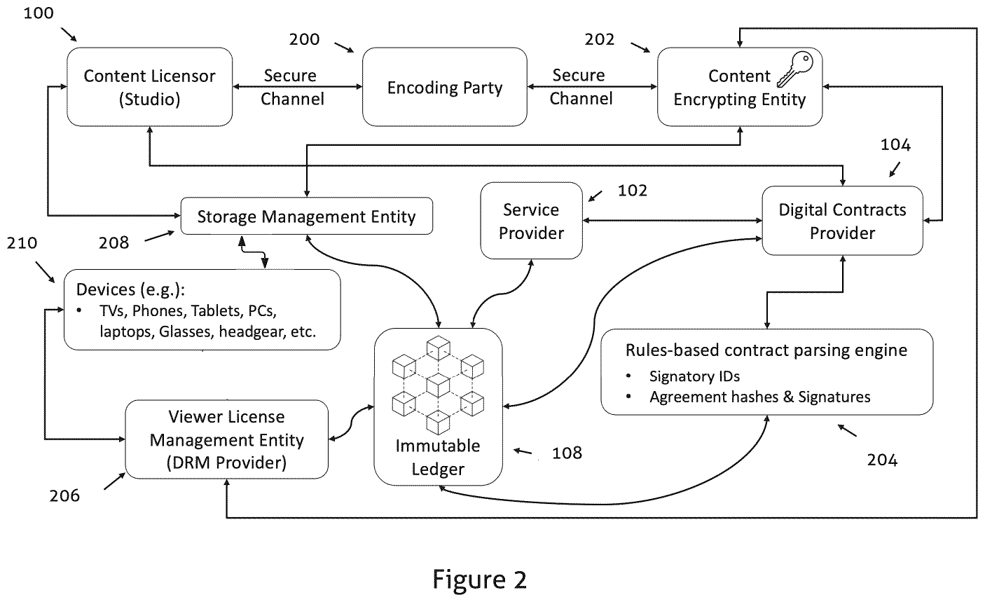

FIG. 2 illustrates a non-limiting example of a content process flow consistent with certain embodiments disclosed herein. Content may be owned and/or controlled by a content provider and/or licensor 100. As discussed herein, the content provider and/or licensor 100 may be, for example and without limitation, a film and/or or TV studio, but it could be any rightsholder who owns the right to control the distribution of content. For example, the content provider and/or licensor 100 could, in some embodiments, be a single creator making home videos or a film studio that spends hundreds of millions of dollars to create a film. After content has been created, mechanisms disclosed herein may be used to protect and/or manage the content.

The content provider and/or licensor 100 may encode content in a variety of distributable forms (e.g., standard definition AVC, Hi Def, etc.). In some embodiments, the content provider and/or licensor 100 may perform the encoding themselves. In further embodiments, the content provider and/or licensor 100 may coordinate encoding with a third party, which may be referred to as an encoding party 200. In certain embodiments, the content may be sent to the encoding party 200 via a secure channel. The encoded, but not yet encrypted, content may then be sent over a secure channel to a content encrypting entity 202, also over a secure channel, for encryption.

The content encrypting entity 202 may generate the content key and encrypt the content. In some embodiments, the content encrypting entity 102 may provide certain DRM services. In further embodiments, a separate DRM service may be used. In some embodiments, the content encrypting entity 202 may have sufficient credentials and security audit records to give the content provider and/or licensor 100 assurance of the security of their content. It will be appreciated that in further implementations, the functions of the content provider and/or licensor 100, encoding party 200, and/or encrypting entity 202 may be operated by separate services and/or systems, and/or by any suitable combination of systems and/or services including a single system and/or service.

Digital contracts consistent with various embodiments disclosed herein may be managed by a digital contracts provider 104. For example, the digital contracts provider 104 may manage agreements between the content provider and/or licensor 100 and/or service provider(s) 102. In various embodiments, the digital contracts provider 104 could write the entire digital contract to the trusted ledger 108 (in the clear, encrypted, and/or partially encrypted). In further embodiments, contracts may be stored in a cloud service by the digital contracts provider 104 and the location of the contract, a signature and/or the hash of the contract, an encrypted version of the and/or identities of the signatories to the digital contract may be stored in the immutable ledger 108. It will be appreciated that contracts may be stored and/or managed in a variety of ways consistent with various aspects of the disclosed embodiments, and the illustrated implementations and various storage and/or management architectures described herein are to be considered illustrative and non-limiting.

In certain embodiments, digital contracts may have public and/or private components. For example, certain content parameters included in a digital contract, which may include those evaluated in connection with DRM license generation and/or issuance, may be less sensitive and thus viewable publicly. Other parameters, however, which may include certain provisions parameters between a content producer and/or licensor 100 and/or a service provider 102 (e.g., renumeration provisions) may be more sensitive. In some embodiments, records included in a trusted ledger may include the public components and/or indications thereof (e.g., in the clear and/or hashes of the components that may be used to access the associated information elsewhere in the clear), encrypted and or hashed versions of the private components, and/or a hash of the entire digital contract (including both public and private components). In this manner, publicly available components may be accessible (e.g., for DRM license generation purposes), private components may be protected, with the private components and/or the entire digital contract being verifiable and/or authenticatable via hash checks.

As detailed herein, content parameters may be expressed in a variety of ways. For example, one or more rules may be offered by a content licensor 100 may be selected from a plurality of established and/or predefined structured rules. To speed checks against the trusted ledger 108 in connection with rules parsing and/or DRM license generation, a particular combination of rules may be expressed as a hash value and/or other identifier of the constituent rules. These “rule set” hashes and/or values can then be used as an identifier of a particular combinatorial rule set, allowing for quick lookup of identifying distribution rules and/or content parameters associated with a content item in connection with DRM license generation and more expedient checks against the trusted ledger 108.

In various embodiments, the digital contract may be immutable by reference. That is, due to a hash associated with the contract stored in the trusted ledger 108, the digital contract may not be changed without being invalidated. The parameters reflected in the digital contract may be acted upon may be provided to a rules-based parsing engine 204, which may determine when and where associated content can be played with the rules it enforces. These rules may be passed dynamically to a viewer license management entity 206 which may implement DRM services (and in some instances herein may be generally referred to as a DRM service). In some embodiments, the viewer license management entity 206 may be a provider of multiple DRM services and/or DRM implementations. Because there may be some risk of attacking the connection between the rules-based parsing engine 204 and the viewer license management entity 206, in various embodiments a secure channel and/or a channel with robust authentication may be used for the connection. It will be appreciated that although illustrated as separate services, in further embodiments functions of the rules-based parsing engine 204 and the viewer license management entity 206 may be provided by a single entity, service, and/or system and/or any suitable combination of entities, services, and/or systems.

Consistent with embodiments disclosed herein, a consumer of content may view, use, playback, and/or otherwise render content via one or more client devices 210 if permitted by applicable DRM licenses issued by the viewer license management entity 206. The client devices 210 may comprise, for example and without limitation, a TV, phone, tablet and/or smartphone, personal desktop computer, laptop, smart glasses, headgear and/or virtual and/or augmented reality headsets, and/or any other system, device, and/or apparatus that may be used to access, playback, render, and/or otherwise use content. In connection with viewing, using, playing back, and/or otherwise rendering content via the one or more client devices 210, the device(s) 210 may interact with the viewer license management entity 206 to obtain an applicable DRM license. The viewer license management entity 206 may check the trusted ledger 108 for content parameters recorded in a ledger entity and/or associated digital content associated with the content and generate and issue a DRM license with appropriate content decryption keys (e.g., provided by the content encrypting entity 202) to the client devices 210 if applicable content parameters reflected in the ledger 108 are satisfied.

In various embodiments, a storage management entity 208 may be used to store content 208 and/or deliver it to devices 210 (e.g., deliver via download and/or streaming operations). In some embodiments, the storage management entity 208 may itself store and deliver requested content to the client devices 210. In further embodiments, the storage management entity 208 may manage and/or otherwise coordinate the storage of content in one or more remote and/or cloud storage services. In some embodiments, locations of content stored within the storage management entity 208 and/or elsewhere (e.g., URLs) may be recorded in associated entries in the trusted ledger 108 and may be accessed by the client devices 210 and/or the storage management entity 208 in connection with content delivery operations.

In further embodiments, to facilitate a more streamlined user experience, in streaming contexts content may be pre-rolled with initial unencrypted portions of a content item played at the start of a file. This may allow time for license checking and acquisition without buffering before encrypted portions of the content item that require a valid DRM license for decryption begin.

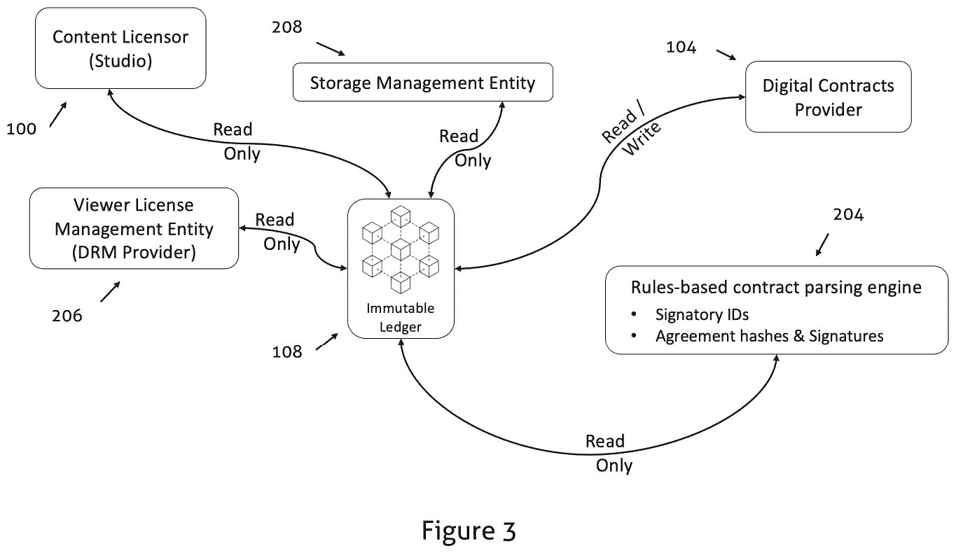

FIG. 3 illustrates a non-limiting example of content management using a trusted ledger 108 consistent with certain embodiments disclosed herein. As discussed above, there are many different kinds of immutable ledgers, TIDALs, and/or blockchains with cryptographically linked ledger entries that may be used in connection with various disclosed embodiments. In various embodiments, any type of trusted ledger and/or blockchain may be used including, for example, public private, hybrid, and/or consortium blockchains. In some implementations, one or more permissioned blockchains and/or ledgers may be used.

As illustrated in FIG. 3, in certain embodiments, some entities may be allowed to read from and/or write to the trusted ledger 108 while others may only read from it. The reasoning behind such embodiments is that those entities with a need to update the trusted ledger 108 may have access to write to the ledger 108 while other participants in the ecosystem may be allowed to read from the ledger 108. It will be appreciated, however, that although certain read and/or write privileges between entities are indicated in the figures and detailed herein, other implementations may not necessarily include the same read/write privileges as shown.

In various embodiments, the trusted ledger 108 may be used within the ecosystem as a source of truth for digital contracts associated with content. The digital contracts, as recorded in the trusted ledger 108 may include, for example and without limitation, one or more of the location, date, signatories, digital signature, and/or and hash of each digital contract. Digital contracts may be stored in the trusted ledger 108 by the digital contracts provider 104.

A rules-based parsing engine 204 may read the trusted ledger 108 to retrieve an address of the relevant digital contract for a content item, which it may parse in order to define the parameters for the generation of a DRM license. It may pass these parameters to the viewer license management entity 206 providing DRM services that may generate the DRM licenses. Though the rules parsing entity and the DRM vendor may be the same entity, it will be appreciated that a variety of other implementations may be used, including implementations where the rules parsing entity and the DRM vendor may be separate entities and/or implemented by separate systems and/or services (e.g., as may be the case where a service provider uses their own DRM architecture).

In some embodiments, the storage management entity 208 may read the trusted ledger 108 to identify locations of content files for storage and/or playback (e.g., cloud storage locations and/or the like). In further embodiments where the storage management entity 208 stores the content files itself, entries in the trusted ledger 108 may identify the storage location in the storage management entity 208 itself.

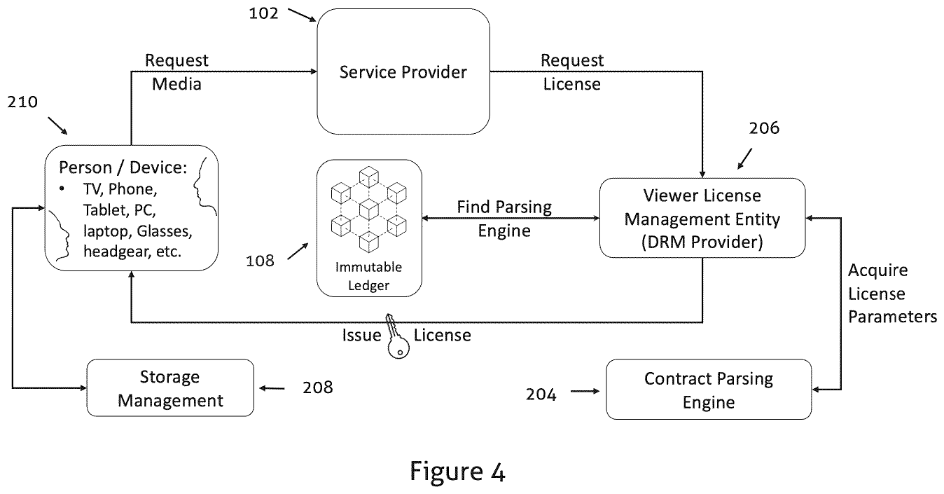

FIG. 4 illustrates a non-limiting example of a playback architecture consistent with certain embodiments disclosed herein. Specifically, the illustrated playback architecture shows a non-limiting example of content playback from a consumer and/or viewer perspective.

An individual using their client device 210 may request a media and/or content element (e.g., purchase, rental, subscription, etc.) from a service provider 102. The service provider 102 may want to fulfill the request. In certain instances, the service provider 102 may have already taken and/or will take payment and/or have confirmed other entitlement like a subscription from the individual associated with the client device 210 which may give them the right have the media request fulfilled. The service provider 102 may request, on the individual's behalf and/or in response to the media request, a license from the viewer license management entity 206 providing DRM services. In connection with the license request, the service provider 102 may send the viewer license management entity 206 customer information associated with the client device 210 and/or associated user sufficient to determine playback capabilities and/or other parameters (e.g., term of request, media title, territory, resolution, etc.).

The viewer license management entity 206 may query the trusted ledger 108 to identify content parameters included in a digital contract associated with the requested content. The contract parsing engine 204 may receive the content parameters and/or digital contract and may parse relevant license parameters (e.g., service provider, customer details, territory, resolution, etc.), providing the acquired parameters to the viewer license management entity 206 for generation of a DRM license. The viewer license management entity 206 may generate a DRM license and return it to the service provider 102 and/or the client device 210.

The client device 210 may interact with the storage management service 208 in connection with receiving the content via a download, stream, and/or the like. The client device 210 may use the provisioned DRM license and/or cryptographic keys included therein to decrypt and enable playback of the content consistent with the DRM license terms (e.g., as may be enforced by a DRM engine and/or client operating on the client device 210.

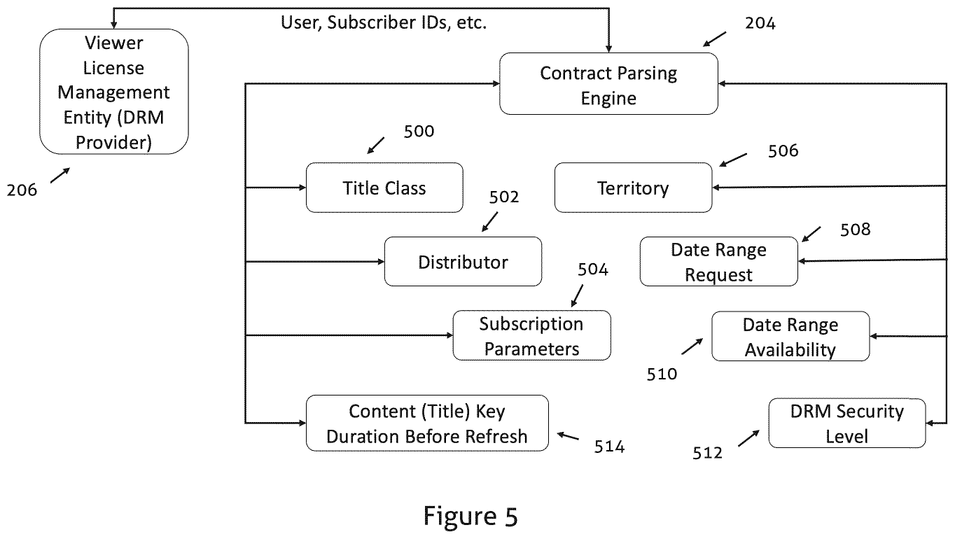

FIG. 5 illustrates a non-limiting example of compliance validation consistent with certain embodiments disclosed herein. To determine if and/or for how long and under what circumstances a license can be issued for a given element of content, a variety of parameters may be considered. It will be appreciated that various parameters and any others that may be relevant for a particular environment or application can be many and varied and may be parsed in any number of different orders by one practiced in the art.

It will also be appreciated that in some embodiments, the DRM service may perform DRM license compliance validation at various times during interaction with a client device. For example and without limitation, certain DRM license checking, generation, issuance, and/or validation processes may be performed one or more times before and/or during an interaction with a client device. For example, a “pre-run” check of parameters associated with a particular user may be conducted prior to providing the user a particular offer of content. The results of this “pre-run” license check query may result in a service provider and/or DRM service not displaying a particular viewing option to a user, removing an option, disabling and option (e.g., greying out an option), and/or the like. In various embodiments, the services may repeat license checks prior to actually issuing DRM licenses in the event circumstances has changed with from the time of the “pre-run” check.

When the viewer license management entity 206—that is, the DRM service—wants to issue a license to enable the rendering of content, it may query the contract parsing engine 204, passing it the parameters of the request. The request parameters may comprise, for example and without limitation, one or more of a content title, subscriber identifier, associated territory, and/or the like. The contract parsing engine 204 may match the parameters of the request to one or more content parameters and/or rules represented by the relevant digital contract recorded to the trusted ledger.

The contract parsing engine 204 may match the parameters of the request to the rules represented by the relevant contract. In at least one non-limiting example, the contract parsing engine 204 may first check the title class 500. The title class 500, while not required in all embodiments and/or implementations, may facilitate certain operations for studios and/or other content creators. In various embodiments, various title classes 500 may be associated with different security levels and/or requirements used in license generation and/or enforcement.

Title classes 500 may include, for example and without limitation, one or more of: (1) Promotional video (e.g., little to no security required but usage tracking may be required), (2) Academy reviewer copies (e.g., sent to reviewers and voting members of the film academy, no charge but viewable within a specific limited time window), (3) Early window content (e.g., very high value content possibly at a premium price available to a limited audience for a limited period of time), (4) Ad supported content (e.g., no fee but ads cannot be skipped), (5) North American territory only (or other suitable territory restrictions), (6) Require trusted execution environment (“TEE”), (7) Rentable for a period of time, and/or the like. It will be appreciated that a variety of title classes may be used in connection with the disclosed embodiments, and that the examples listed above are to be considered as illustrative and not restrictive.

In certain embodiments, title classes 500 can be defined by each content creator out of any arbitrary set of parameters. Those parameters may be limited in connection with a particular distributor 502 and/or subscription service, which may be included and/or otherwise identified in the parsed rules and/or parameters. In at least one non-limiting example, one subscription service might have a different relationship with the content licensor or have different back-end security mechanisms. Contract parameters may further comprise, for example and without limitation, one or more of subscription parameters 504, which may articulate the terms of the subscription (e.g., standard definition only or only on one device at a time or included with a particular package like sports, etc.), territory parameters 506, date range request 508, date range availability 510, DRM security level 512, content key duration before refresh 514, and/or the like.

A common attack vector for the unapproved copying of content is the capture of the content key, as once an attacker has the content key, they can decrypt the content. By using multiple content keys, it becomes more difficult and inconvenient for both pirates and consumers of illegitimate content. First for the pirate, if they have only one content key of perhaps dozens of possible keys, they must also distribute the content with that key or decrypt the content and distribute it. Both of these scenarios are much more traceable and/or expensive than just releasing the key in the wild. Also, if the consumer has one pirated key, but the content they get is for another encryption encoding, they cannot use the ill-gotten key as it will not work. For the most secure environments, keys can be rotated within one copy so that it is even harder to copy, and the media can either be streamed with the successive keys delivered sequentially or downloaded with a set of keys. Additionally, different versions can be given different sets of keys making it even more difficult to pirate. Consistent with embodiments disclosed herein, content key duration/refresh information included the parsed rules and/or parameters may be used by the DRM license service 206 to cycle keys included in DRM licenses in a manner that mitigates the above-detailed piracy concerns.

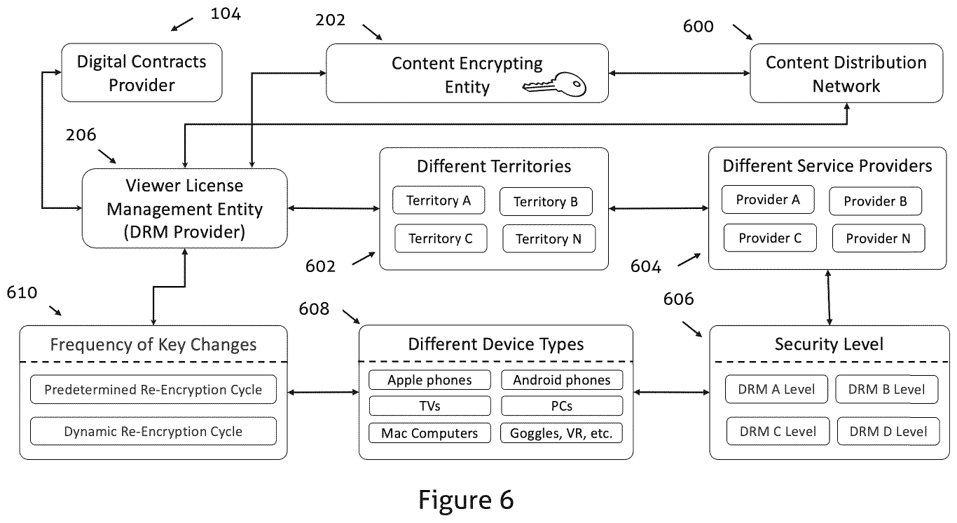

FIG. 6 illustrates a non-limiting example of the management of re-encrypted content consistent with certain embodiments disclosed herein. It will be appreciated that the management process shown in FIG. 6 is merely an illustrative example, and that other content re-encryption processes may also be used.

When a consumer wants to render content via a client device, their client device may issue a request to the DRM service 206 for issuance of a DRM license. The digital contracts provider 104 may, in certain implementations, operate as a source of truth with regard to when keys need to be changed and the DRM service may check with the contracts provider 104 to determine the current obligations and restrictions. These decisions may be stipulated in digital contracts which can be changed and updated at any time via interactions with the trusted ledger. What follows is one non-limiting exemplary order, but many different orders could be chosen based likely on the parameters that are most likely to change to minimize latency. In at least one non-limiting example, the first branch may be based on the choice of territory 602. Once the choices have been limited by territory, the choices may be next limited by the choice of service provider 604. Once that branch has been parsed, the next branch may be based on DRM security level 606, followed by device type 608.

Once the DRM service 206 has the parameters and matches them against the digital contract, it may determine whether to issue a license or not and under what terms and within what time limitations. In some embodiments, once a key expiration is configured by the content provider and/or licensor, the content encrypting entity 202 can determine when re-encryption is required. If so, the content encrypting entity 202 can run re-encryption processes before a key expires and, when re-encryption is completed, it can call the contracts provider 104 to update the key generation date in the trusted ledger.

If the DRM service 206 has determined that a new content key is needed, it may contact the content encrypting entity 202 and ask for a new encryption. This newly encrypted file may be sent to the content distribution network 600 and a link to the file may be returned. The DRM service 206 may have the location of the file and the key to decrypt the file and can issue the license to the client device if it has passed the parameters necessary for rendering. It will be appreciated that these can be performed by push and/or pull message, publish subscribe, and/or any of a number of synchronization mechanisms.

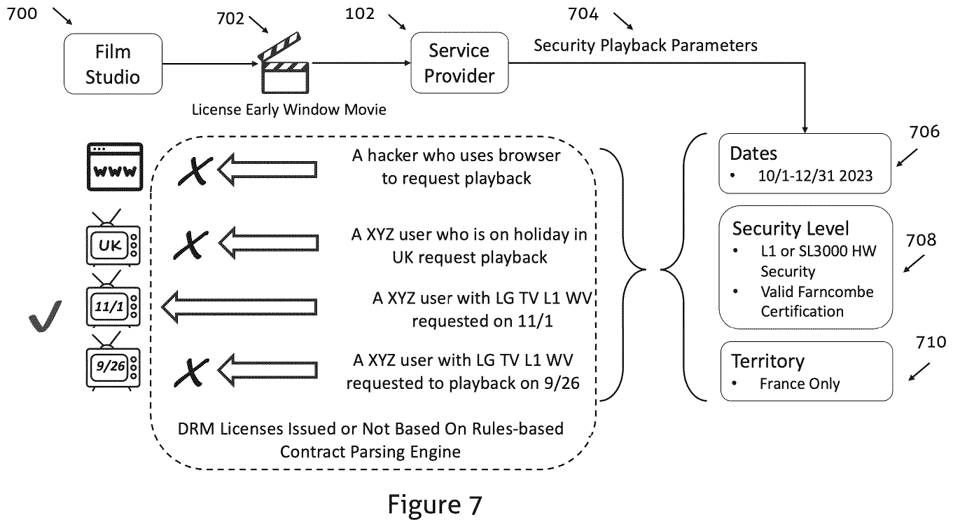

FIG. 7 illustrates a non-limiting example of various playback limiting parameters consistent with certain embodiments disclosed herein. In the illustrated example, a film studio 700 may create a high value film and want to make it available in what is called “an early release window” 702. That is, some people may pay a premium in order to see the film before it is more widely available on content platforms. The film may be provided to the service provider 102 for distribution in accordance with terms that may be set by the film studio 700, which may be expressed as content and/or security playback parameters 704 included in a digital contract recorded in a trusted ledger. In the non-limiting illustrated example, the security playback parameters 706 for viewing the film may be: It can only be viewed between Oct. 1 and Dec. 31, 2023, the security level 708 should be L1 or SL3000 hardware security and have a valid Farncombe certification and the territory 710 is limited to France.

DRM licenses may be issued or not based by a DRM service on the content parameters and/or rules encoded in the digital contract. In the illustrated example, a variety of individuals may try to access the content. For example, a hacker may attempt to user a browser to request playback on a personal computer, a first user of XYZ service who is on holiday in the UK may attempt playback on a smartphone device, and a second user of XYZ service with LG TV L1 WV device may attempt playback on 9/26. In these three circumstances, DRM licenses may not be issued. For example, hacker's attempt may fail due to security requirements, the first user may not be issued a DRM licenses because of territorial restrictions, and the second user may not be issued a DRM licenses because their request is outside the allowed time window. A third user of XYZ service operating in France with an LG TV device with L1 WV that issue a request on 11/1, however, may successfully obtain a DRM license because of meeting security, territorial, and/or time window requirements. In this manner, rules and/or parameters relating to the content which may be articulated by the film studio 700 may be enforced by the system in connection with the issuance of DRM licenses by a license service.

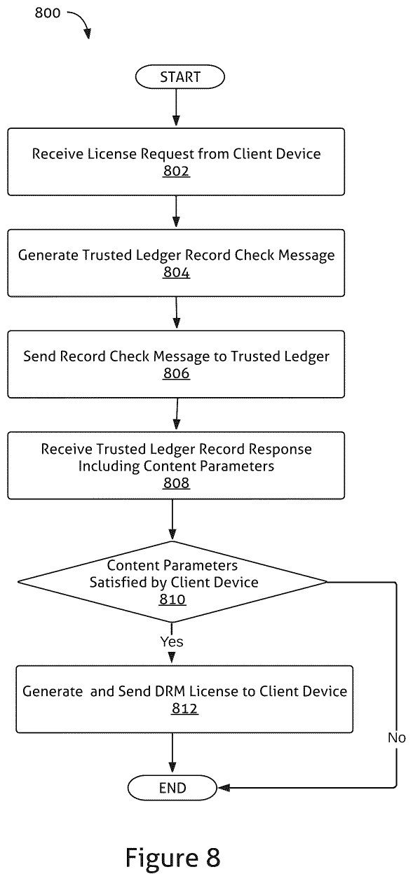

FIG. 8 illustrates a flow chart of a non-limiting example of a method 800 for managing content using digital rights management license generation and issuance levering trusted ledgers consistent with certain embodiments of the present disclosure. The illustrated method 800 may be implemented in a variety of ways, including using software, firmware, hardware, and/or any combination thereof. In certain embodiments, various aspects of the method 800 and/or its constituent steps may be performed by a service, system, and/or device configured to implement embodiments of a DRM service and/or any other suitable application, device, system and/or service or combination of applications, devices, systems, and/or services.

At 802, a license request may be received from a client device. The license request may include, for example and without limitation, content item identifier information (e.g., a content ID) and information associated with the client device. For example and without limitation, the license request may comprise information relating to a user and/or an account associated with the client device, device identifier information, information relating to hardware and/or software and/or associated environments of the client device, and/or the like.

A trusted ledger record check message may be generated at 804. The ledger record check message may, in some implementations, comprise at least the content item identifier, although other relevant information may also be included in the message. The trusted ledger record check message may be sent to a trusted ledger service managing a trusted ledger at 806. As detailed herein the trusted ledger may comprise cryptographically linked ledger entries to provide immutability of its entries and, in certain implementations, may be a TIDAL and/or a blockchain ledger.

At 808, a trusted ledger record response to the check message may be received from the trusted ledger service. Consistent with various disclosed embodiments, the trusted ledger record response may comprise an indication of plurality of content parameters associated with the content item identifier recorded in an entry of the trusted ledger. The indication may, in some implementations, be the explicit content parameters themselves. In further embodiments, the indications may comprise a hash and/or some other value associated with the plurality of parameters that may be used to identify (e.g., via a hash lookup and/or the like) the explicit content parameters. In various embodiments, the information included in the trusted ledger record response may include information parsed from a record entry in the trusted ledger, which may comprise at least one of the content item identifier and the indication of the plurality of content parameters. In some embodiments, the record entry may further comprise a signature associated with a content product associated with the content item, which may be included in the record response and validated by the rights management service.

The plurality of content parameters may comprise a variety of parameter information, conditions, rules, and/or the like. For example and without limitation, the content parameters may comprise one or more temporal parameters relating to the playback of a content file associated with the content item identifier, one or more geographic parameters relating to the playback of the content file, one or more, hardware environment parameters relating to the playback of the content file, one or more software environment parameters relating to the playback of the content file, and/or one or more parameters relating to users and/or accounts associated with the client device.

At 810, it may be determined based on the client device information and the plurality of content parameters that the plurality of content parameters are satisfied by the client device and that playback is permitted. For example and without limitation, the client device information may be compared with one or more content parameters of the plurality of content parameters to determine whether the one or more content parameters are satisfied.

If the content parameters are satisfied by the client device, a DRM license may be generated at 812. The DRM licenses may comprise a content decryption key associated with the content item identifier. The content decryption key may be received by the DRM service from a content encryption service. The content decryption key may be used to decrypt an encrypted content file associated with the content item identifier. As detailed herein the content file may comprise one or more of audio content, video content, image content, and/or text content. The generated DRM license may be provisioned to the client device from the DRM service.

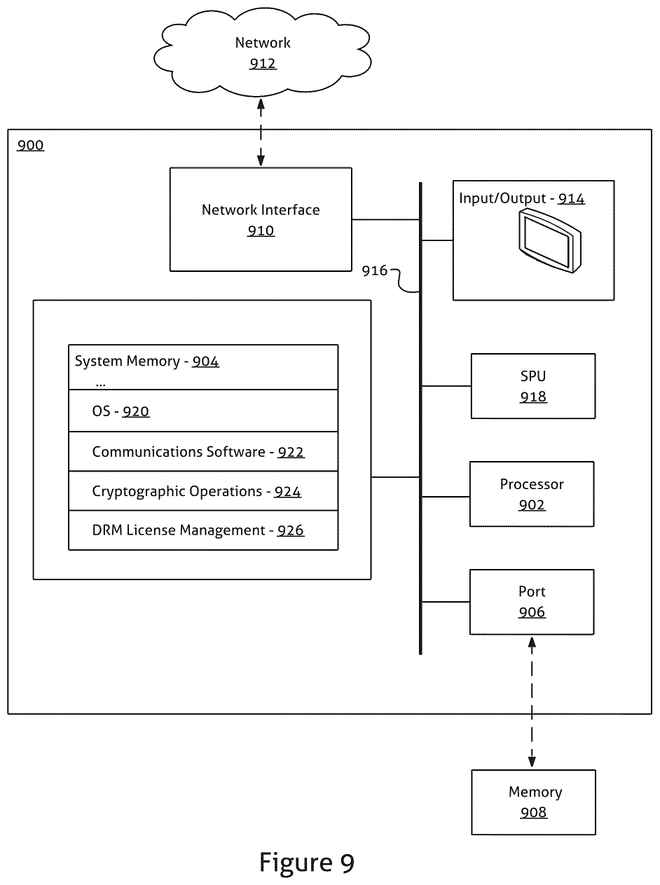

FIG. 9 illustrates a non-limiting example of a system 900 that may be used to implement certain embodiments of the systems and methods of the present disclosure. The system 900 of FIG. 9 and/or aspects thereof may be included in a system, service, and/or device associated with any of the systems, devices, services, and/or entities described herein (and/or combinations of the same), and/or any other service, which may comprise a trusted service, system, and/or component configured to implement embodiments of the disclosed systems and methods and/or aspects thereof.

The various systems and/or devices used in connection with aspects the disclosed embodiments may be communicatively coupled using a variety of networks and/or network connections (e.g., network 912). In certain embodiments, the network 912 may comprise a variety of network communication devices and/or channels and may utilize any suitable communications protocols and/or standards facilitating communication between the systems and/or devices. The network 912 may comprise the Internet, a local area network, a virtual private network, and/or any other communication network utilizing one or more electronic communication technologies and/or standards (e.g., Ethernet or the like). In some embodiments, the network 912 may comprise a wireless carrier system such as a personal communications system (“PCS”), and/or any other suitable communication system incorporating any suitable communication standards and/or protocols. In further embodiments, the network 912 may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In certain embodiments, the network 912 may incorporate one or more satellite communication links. In yet further embodiments, the network 912 may utilize IEEE's 802.11 standards, Bluetooth, ultra-wide band (“UWB”), Zigbee®, and or any other suitable standard or standards.

The various systems and/or devices used in connection with aspects of the disclosed embodiments may comprise a variety of computing devices and/or systems, including any computing system or systems suitable to implement the systems and methods disclosed herein. For example, the connected devices and/or systems may comprise a variety of computing devices and systems, including laptop computer systems, desktop computer systems, server computer systems, distributed computer systems, smartphones, tablet computers, and/or the like.

In certain embodiments, the systems and/or devices may comprise at least one processor system configured to execute instructions stored on an associated non-transitory computer-readable storage medium. As discussed in more detail below, systems used in connection with implementing various aspects of the disclosed embodiments may further comprise a secure processing unit (“SPU”) configured to perform sensitive operations such as trusted credential and/or key management, cryptographic operations, secure policy management, and/or other aspects of the systems and methods disclosed herein. The systems and/or devices may further comprise software and/or hardware configured to enable electronic communication of information between the devices and/or systems via a network using any suitable communication technology and/or standard.

As illustrated in FIG. 9, the example system 900 may comprise: a processing unit 902; system memory 904, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 902; a port 906 for interfacing with removable memory 908 that may include one or more diskettes, optical storage mediums (e.g., flash memory, thumb drives, USB dongles, compact discs, DVDs, etc.) and/or other non-transitory computer-readable storage mediums; a network interface 910 for communicating with other systems via one or more network connections and/or networks 912 using one or more communication technologies; a user interface 914 that may include a display and/or one or more input/output devices such as, for example, a touchscreen, a keyboard, a mouse, a track pad, and the like; and one or more busses 916 for communicatively coupling the elements of the system.

In some embodiments, the system 900 may, alternatively or in addition, include a trusted execution environment and/or an SPU 918 that is protected from tampering by a user of the system or other entities by utilizing secure physical and/or virtual security techniques. A trusted execution environment and/or a SPU 918 can help enhance the security of sensitive operations such as personal information management, trusted credential, token, and/or key management, privacy and policy management, and other aspects of the systems and methods disclosed herein. In certain embodiments, the trusted execution environment and/or SPU 918 may operate in a logically secure processing domain and be configured to protect and operate on secret information, as described herein. In some embodiments, the trusted execution environment and/or a SPU 918 may include internal memory storing executable instructions or programs configured to enable the SPU 918 to perform secure operations, as described herein.

The operation of the system 900 may be generally controlled by the processing unit 902 and/or an SPU 918 operating by executing software instructions and programs stored in the system memory 904 (and/or other computer-readable media, such as memory 908, which may be removable). The system memory 904 may store a variety of executable programs or modules for controlling the operation of the system. For example, the system memory may include an operating system (“OS”) 920 that may manage and coordinate, at least in part, and/or system hardware resources and provide for common services for execution of various applications.

The system memory 904 may further include, without limitation, communication software 922 configured to enable in part communication with and by the system, one or more applications, a cryptographic operation module 924 configured to perform various aspects of the disclosed embodiments (e.g., cryptographic key and hash generation operations, key management operations, encryption operations, etc.), one or more DRM license generation and/or management engines 926 configured to perform various aspects of the methods disclosed herein, and/or any other information, modules, and/or applications configured to implement embodiments of the systems and methods disclosed herein.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. For example, it will be appreciated that a number of variations can be made to the various embodiments, systems, services, and/or components presented in connection with the figures and/or associated description within the scope of the inventive body of work, and that the examples presented in the figures and described herein are provided for purposes of illustration and explanation, and not limitation. It is further noted that there are many alternative ways of implementing both the systems and methods described herein. Accordingly, the present embodiments are to be considered as illustrative and not restrictive, and the embodiments of the invention are not to be limited to the details given herein but may be modified within the scope and equivalents of the appended claims.

1. A method for managing content by a digital rights management license service executing on system comprising a processor and a non-transitory computer-readable storage medium storing instructions that, when executed by the processor, cause the system to perform the method, the method comprising:
receiving, from a client device, a license request, the license request comprising a content item identifier and client device information;
generating a trusted ledger record check message, the trusted ledger record check message comprising the content item identifier;
sending the trusted ledger record check message to a trusted ledger service managing a trusted ledger;
receiving, from the trusted ledger service, a trusted ledger record response, the trusted ledger record response comprising an indication of a plurality of content parameters associated with the content item identifier recorded in the trusted ledger;
determining, based on the client device information and the plurality of content parameters, that plurality of content parameters are satisfied by the client device; and
generating, based on the determination, a digital rights management license, the digital rights management license comprising a content decryption key associated with the content item identifier; and
sending the generated digital rights management license to the client device.

2. The method of claim 1, wherein the client device information comprises information relating to a user of the client device.

3. The method of claim 1, wherein the client device information comprises information relating to a hardware environment of the client device.

4. The method of claim 1, wherein the client device information comprises information relating to a software environment of the client device.

5. The method of claim 1, wherein determining that the plurality of content parameters are satisfied by the client device comprises comparing the client device information with one or more content parameters of the plurality of content parameters to determine whether the one or more content parameters are satisfied.

6. The method of claim 1, wherein the plurality of content parameters comprise at least one temporal parameter relating to the playback of a content file associated with the content item identifier.

7. The method of claim 1, wherein the plurality of content parameters comprise at least one geographic parameter relating to the playback of a content file associated with the content item identifier.

8. The method of claim 1, wherein the plurality of content parameters comprise at least one hardware environment parameter relating to the playback of a content file.

9. The method of claim 1, wherein the plurality of content parameters comprise at least one software environment parameter relating to the playback of a content file.

10. The method of claim 1, wherein the plurality of content parameters comprise at least one parameter relating to an account associated with the client device.

11. The method of claim 1, wherein the trusted ledger record response comprises information parsed from a record entry in the trusted ledger, the record entry comprising at least one of the content item identifier and the indication of the plurality of content parameters.

12. The method of claim 11, wherein the indication of the plurality of content parameters comprises the plurality of content parameters.

13. The method of claim 11, wherein the indication of the plurality of content parameters comprises a hash value associated with the plurality of content parameters.

14. The method of claim 11, wherein the record entry further comprises a cryptographic signature associated with a content producer associated with a content item associated with the content item identifier, wherein the trusted ledger record response further comprises the cryptographic signature, and wherein the method further comprises validating the cryptographic signature.

15. The method of claim 1, wherein the method further comprises receiving the content decryption key from a content encryption service.

16. The method of claim 15, wherein the content decryption key is configured to decrypt an encrypted content file associated with the content item identifier, the content file comprising at least one of audio content, video content, and text content.

17. The method of claim 1, wherein the trusted ledger comprises cryptographically linked entries.

18. The method of claim 17, wherein the trusted ledger comprises a trusted immutable distributed assertion ledger.

19. The method of claim 18, wherein the trusted immutable distributed assertion ledger comprises a blockchain ledger.
